(19) United States
(12) Patent Application Publication
(10) Pub. No.: US 2011/0099464 A1
(43) Pub. Date: Apr. 28, 2011

(54) MECHANISM FOR ADDING CONTENT FROM A SEARCH TO A DOCUMENT OR MESSAGE

(75) Inventors: Bijan M. Marashi, San Francisco, CA (US); Jonathan Steven Bruck, San Francisco, CA (US); Jonathan Katzman, San Francisco, CA (US)

(73) Assignee: YAHOO! INC., Sunnyvale, CA (US)

(21) Appl. No.: 12/829,159

(22) Filed: Jul. 1, 2010

Related U.S. Application Data
(60) Provisional application No. 61/255,807, filed on Oct. 28, 2009.

(51) Int. Cl. G06F 17/30; G06F 17/20

(52) U.S. Cl. 715/208; 707/722; 707/E17.014

(57) ABSTRACT

Methods and apparatus for adding content from a search to a document or message such as an electronic mail message are disclosed. A graphical user interface may be provided, where the graphical user interface includes an input portion and a template for generating a document or message. A query including one or more search terms may be received via the input portion of the graphical user interface. Search results associated with the query may be obtained. The search results associated with the query may be provided. A user selection may be received, where the user selection selects at least a portion of the search results. A hypertext link or content from the search results may be added to a document or message generated (or being generated by) via the template, wherein the hypertext link or content from the search results is added to the document or message in response to the user selection.

### RELATED APPLICATIONS

This application claims priority from U.S. Provisional Patent Application No. 61/255,807, Attorney Docket No. YAH1P230P, entitled “MECHANISM FOR ADDING CONTENT FROM A SEARCH TO A DOCUMENT OR MESSAGE,” by Marashi, et al, filed on Oct. 28, 2009, which is incorporated herein by reference for all purposes.

### BACKGROUND OF THE INVENTION

The present invention relates generally to computer implemented search and composition of a document or message using results of the search.

Users of the World Wide Web are familiar with the various services available on the Web for locating content of interest. Search engines are provided by a number of entities and search capabilities are embedded in many web sites. For instance, many web sites provide search applications that enable users to search the content of the web sites.

Unfortunately, many users find that performing a search is often a time-consuming and tedious process. In addition, a user must typically switch contexts repeatedly in order to incorporate search results into the user's work product.

### SUMMARY OF THE INVENTION

Methods and apparatus for adding content from a search to a document or message such as an electronic mail message are disclosed. In accordance with one embodiment, a graphical user interface may be provided, where the graphical user interface includes an input portion and a template for generating a document or message. A query including one or more search terms may be received via the input portion of the graphical user interface. Search results associated with the query may be obtained. The search results associated with the query may be provided. A user selection may be received, where the user selection selects at least a portion of the search results. A hypertext link or content from the search results may be added to a document or message generated (or being generated by) via the template, wherein the hypertext link or content from the search results is added to the document or message in response to the user selection.

In accordance with another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a diagram illustrating an example graphical user interface via which a search query may be submitted in accordance with various embodiments.

FIG. 3 is a diagram illustrating the example graphical user interface shown in FIG. 2 via which search results may be presented after the search query has been executed.

FIG. 4 is a diagram illustrating the example graphical user interface shown in FIG. 3 after selection of content from the search results to be inserted into an electronic mail message.

FIG. 5 is a diagram illustrating an example graphical user interface presenting a plurality of content types for which search results may be provided.

FIG. 6 is a process flow diagram illustrating an example method of adding content associated with a search query to a document or message in accordance with various embodiments of the invention.

FIG. 7 is a simplified diagram of an example network environment in which various embodiments may be implemented.

FIG. 8 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments enable content from search results to be added directly to an electronic document or electronic message such as an electronic mail message. This may be accomplished without extensive user input or context switching. Through the use of a user interface provided in association with a template for generating a document or message, content from search results may be added to the document or message being generated via the template with limited effort from the user.

In order to describe a specific implementation of the disclosed embodiments, the examples set forth herein will be described with reference to the generation of an electronic mail message. However, it is important to note that these examples are merely illustrative, and the disclosed embodiments may be applied to add content from search results to other types of messages or documents. These messages or documents may be generated by a user using a variety of applications or services. Such applications or services may be available via a network such as the Internet (e.g., via a remotely located server) and/or locally (e.g., via a browser and/or memory coupled to a user-operated device).

Various applications or services are available for generating, modifying and sending electronic messages (e.g., electronic mail messages) using various messaging protocols. Examples of electronic messages include electronic mail messages, instant messages, text messages, voice messages, or message postings. For instance, a message may be posted via a social networking site such as Facebook, or may be posted as a “tweet” via Twitter. Thus, the message may be a private message directed to a specific individual or group of individuals. Alternatively, the message may be a public message directed to the general public or a large group of individuals (e.g., via a blog).

Similarly, a number of applications or services are available for generating documents (e.g., files). Some of these applications or services enable a single user to generate or modify a document, while other applications or services enable multiple users to share (e.g., generate, modify, and/or read) a document. A document may be stored as one or more files. Examples of document generation applications include Microsoft Word, Google Docs, and Blogger.

In recent years, the Internet has been a main source of information for millions of users. These users rely on the Internet to search for information of interest to them. One conventional way for users to search for information is to initiate a search query through a search service's web page. Typically, a user can enter a query including one or more search term(s) into an input box on the search web page and then initiate a search based on such entered search term(s). In response to the query, a web search engine generally returns an ordered list of search result documents.

A document may be defined as a Uniform Resource Locator (URL) that identifies a location at which the document can be located. The document may be located on a particular web site, as well as a specific web page on the web site. For instance, a first URL may identify a location of a web page at which a document is located, while a second URL may identify a location of a web site at which the document can be located.

Numerous sources of information are accessible via the Internet. Thus, search results may be obtained via a variety of websites or services. For instance, reviews exist in a variety of websites on the Internet, including e-commerce websites such as Amazon.com, dedicated review websites such as Yelp.com, and aggregation websites such as nextag.com, as well as blogs, forums, newspapers, etc. Other websites provide sources of news, videos (e.g., movies, television shows, lectures), audio files such as music, maps, directions, etc.

A user may wish to perform a search in association with another task that they are performing. For instance, the user may wish to obtain information pertaining to a particular topic to include the information in a document or message that they are generating. Unfortunately, performing a search can be distracting from the task at hand, and may require the user to switch between one application used for generating the document or message, and another application via which a search may be performed. As a result, obtaining the desired search results for use in a document or message can be a frustrating experience.

The disclosed embodiments enable a user to perform a search and easily add (e.g., insert and/or attach) content identified or provided in search results to a document or message. The content that is added to a document or message may include one or more types of content (e.g., link, text, image, video, audio). This may be accomplished via a user-interface that is provided in association with a document or message generation application.

The content that is added to the document or message may include a link to content provided in search results. For instance, the link may be a hypertext link to a web site or web page identified in the search results. Moreover, the content that is added to the document or message may include audio and/or visual content that is accessible directly or indirectly via a hypertext link identified in the search results. Examples of content include, but are not limited to, text (e.g., a phone number, address, and/or directions), a visual image or representation (e.g., a map), an audio file, or a video (which may include audio content, as well as visual content). Examples of videos include television shows, movies, music videos, and informational/instructional videos, as well as videos posted on the Internet via services such as YouTube.

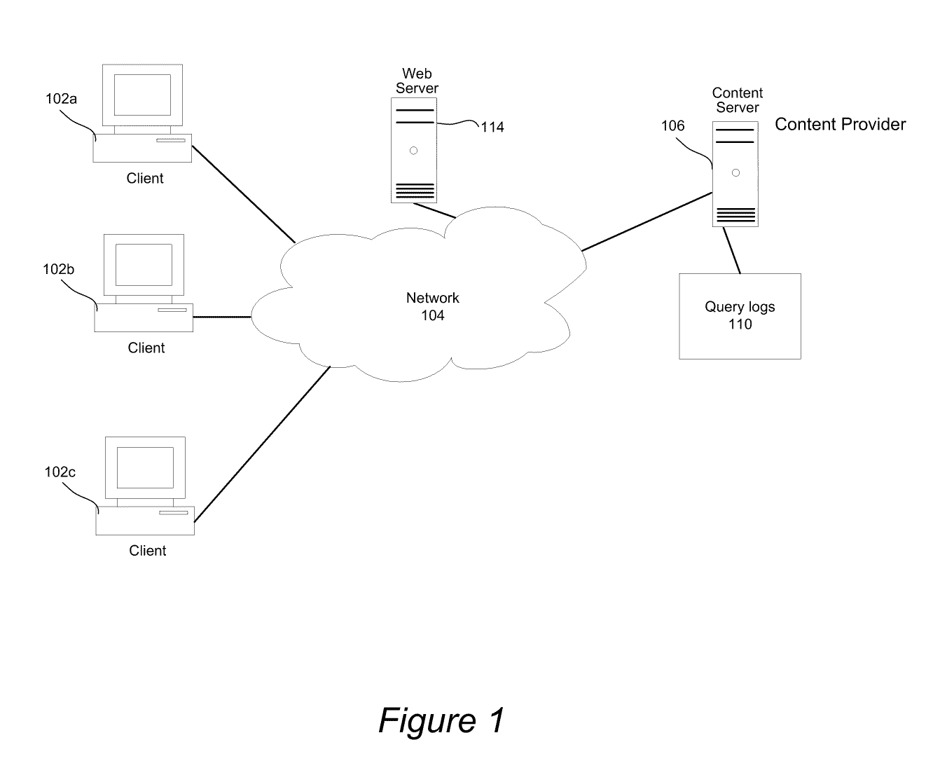

FIG. 1 illustrates an example network segment in which various embodiments of the invention may be implemented. As shown, a plurality of clients 102a, 102b, 102c may access a search application, for example, on search server 106 via network 104 and/or access a web service, for example, on web server 114 via a graphical user interface, as will be described in further detail below. The network may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via network 104 and related to a search query including one or more search terms. The search terms may be entered by a user in any manner. For example, a graphical user interface such as that described in further detail below may present an input feature to the client (e.g., on the client's device) so the client can enter a query including one or more search term(s). In a specific implementation, the graphical user interface presents an input box into which a user may type a query including any number of search terms. Specifically, a graphical user interface may provide an interface for generating a document or message, as well as an interface that operates to receive a search query and/or provide search results associated with the search query. The search query may then be executed via one or more search applications (e.g., associated with search server 106 and/or web server 114) and/or one or more data sources, as will be described in further detail below. Embodiments of the present invention may be employed with respect to any search application. Example search applications include Yahoo! Search, Google, AltaVista, Ask Jeeves, etc. The search application may be implemented on any number of servers although only a single search server 106 is illustrated for clarity.

The search server 106 (or servers) may have access to one or more query logs 110 into which search information is retained. For example, the query logs 110 may be retained in one or more memories that are coupled to the search server 106. Each time a user performs a search on one or more search terms, information regarding such search may be retained in the query logs 110. For instance, the user's search request may contain any number of parameters, such as user or browser identity and the search terms, which may be retained in the query logs 110. Additional information related to the search, such as a timestamp, may also be retained in the query logs 110 along with the search request parameters. When results are presented to the user based on the entered search terms, parameters from such search results may also be retained in the query logs 110. For example, the specific search results, such as the web sites, the order in which the search results are presented, whether each search result is a sponsored or algorithmic search result, the owner (e.g., web site) of each search result, whether each search result is selected (i.e., clicked on) by the user (if any), and/or a timestamp may also be retained in the query logs 110.

Upon receiving a search query, the search server 106 may identify and present the appropriate web pages that are pertinent to the query via a search portion of the graphical user interface, as will be described in further detail below. For instance, the search server 106 may identify and present a plurality of hypertext links that identify content that is pertinent to the search query, as well as present a summary or abstract associated with each of the plurality of hypertext links. The information that is available may be processed and displayed in accordance with various embodiments of the invention, enabling search results to be provided to the user within the context of a document or message generation application or corresponding user interface. The user may then insert at least a portion of the search results directly into the document or message that the user is generating.

Embodiments disclosed herein may be implemented via the search server (or other server) 106 and/or the clients 102a, 102b, 102c. For example, various features may be implemented via a web browser and/or application on the clients 102a, 102b, 102c. The disclosed embodiments may be implemented via software and/or hardware.

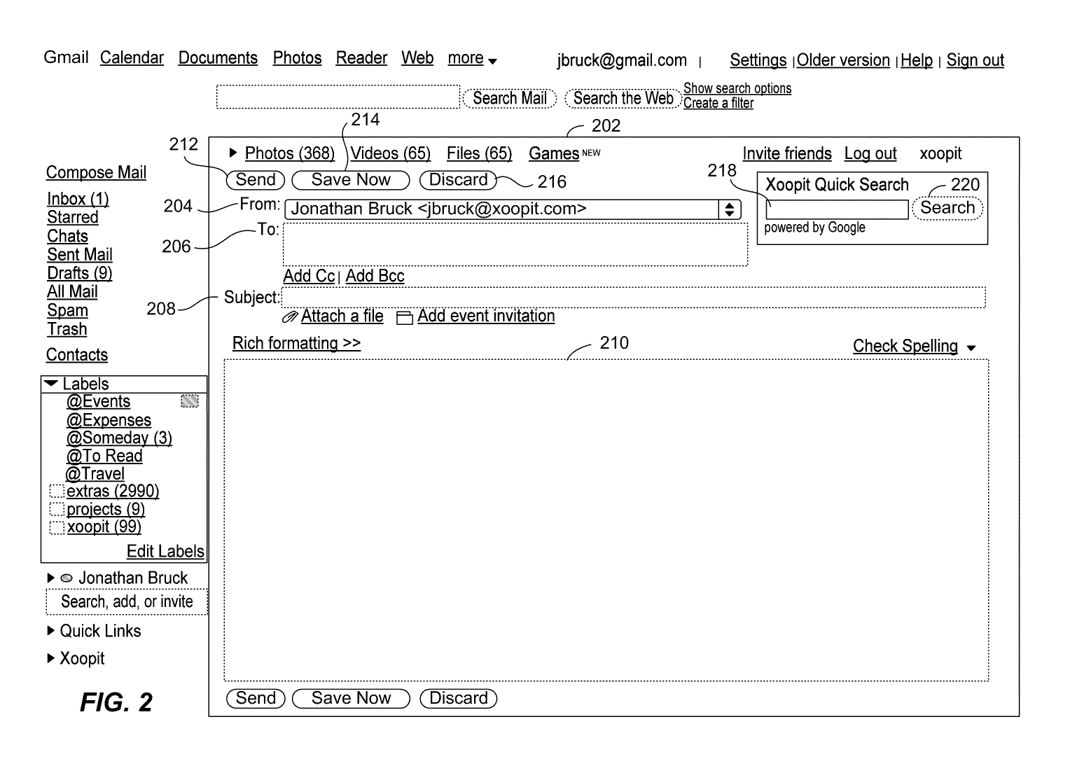

In the example embodiments described below with reference to FIGS. 2-6, a graphical user interface enables a user to add content from search results to an electronic mail message. The electronic mail message may be generated via a template such as that shown and described in further detail below. However, it is important to note that these examples are merely illustrative. Therefore, content from search results may be added to other types of messages or documents using a template and/or graphical user interface in a similar manner. Moreover, various operations such as those described below may be initiated by the user with respect to a message or document, as will be illustrated with reference to the following examples.

Generally, a template (or messaging interface) may include one or more fields and/or segments (i.e., portions) indicating information that may be entered by a user. Each of the fields or segments may be labeled to indicate the type of information to be entered by the user. Moreover, each of the fields or segments may correspond with information that is either mandatory or optional. Specifically, the document or message cannot be completed without mandatory information. In this manner, the template may define a format of a message (or document) to be generated by a particular message or document generation application.

A graphical user interface may be displayed in order to enable a user to submit a search query and/or receive search results while generating a message or document, enabling the user to add content associated with the search results to the message (or document). For instance, through the graphical user interface, a user may submit a search query, initiate a search corresponding to the search query, select one or more content types (e.g., categories) for which search results are to be provided (e.g., displayed), scroll through search results and/or select content from the search results to be added to the electronic mail message. Moreover, the user may also initiate, suspend and/or terminate various operations that may be performed in association with the electronic mail message via the graphical user interface and/or template. The graphical user interface and/or template may include graphics such as one or more icons, pictures, tabs, buttons, panes, and/or menus. A user may interact with the graphical user interface via an input device such as a keyboard and/or mouse.

FIG. 2 is a diagram illustrating an example graphical user interface via which a search query may be submitted in accordance with various embodiments. The disclosed embodiments may interface with or access an electronic message or document application, such as an electronic mail application. As shown in this example, the graphical user interface may include a template 202 (or compose page) via which an electronic mail message may be generated. More particularly, the template 202 may be generated and provided via a document or message generation application.

The template 202 may include one or more fields and/or segments. As shown in this example, the template 202 may include a “From” field 204, a “To” field 206, and/or a “Subject” field 208, as well as a message portion 210. The “From” field 204 may be a mandatory field indicating an identity of the sender of the message, while the “To” field 206 may be a mandatory field indicating an identity of the intended recipient of the message. The “Subject” field 206 may be an optional field, enabling the user to input text describing the subject of the message that is being sent. The user may also choose to add additional recipients to receive a copy of the message. Specifically, the user may choose to “Cc” (e.g., carbon copy) a recipient such that they are identified in a “Cc” field of the message. In addition, the user may choose to “Bc” a recipient such that other recipients of the message are unaware that the recipient who has been “blind copied” has received the message. The user may also choose to attach a file, add an event invitation, and/or Check the Spelling of the message, as shown in this example.

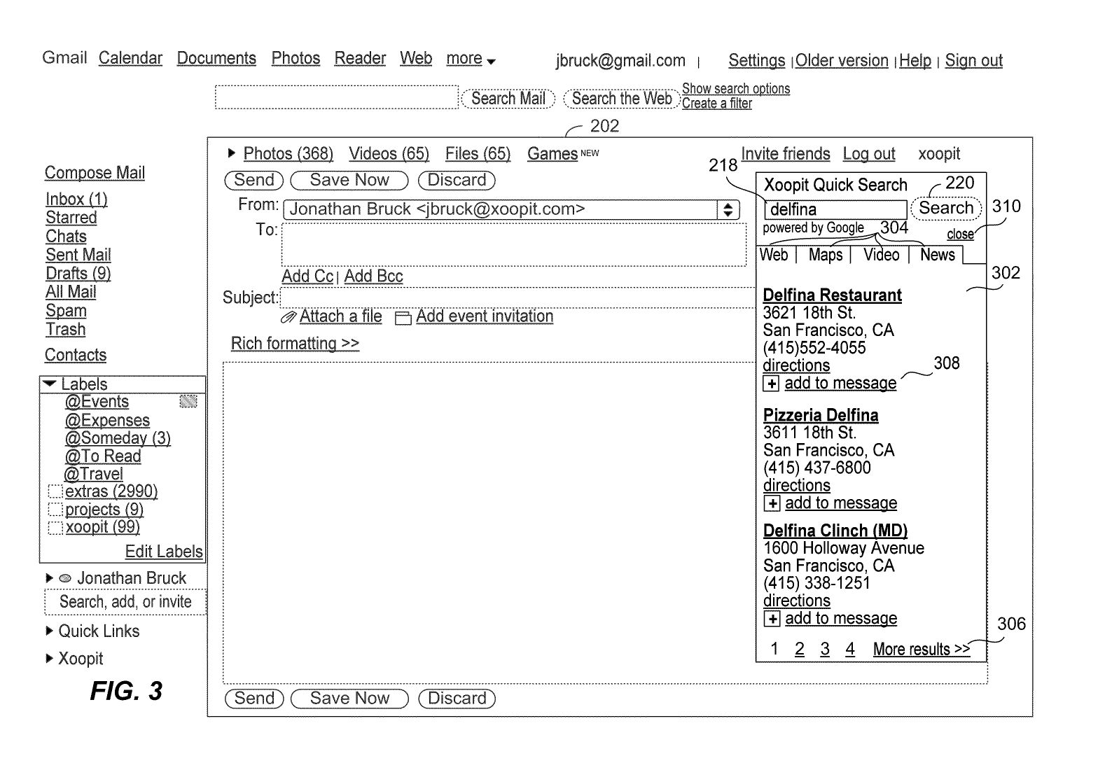

The message portion 210 of the template 202 may designate an area in which a user may enter a message. The message portion 210 may be optional or mandatory. The user may enter at least a portion of the message via typing text using a keyboard. In addition, the user may also add content associated with search results to the message portion 210, as will be described in further detail below with reference to FIGS. 3-5.

The graphical user interface may also enable the user to initiate various operations that may be performed in association with the electronic mail message. In this example, the user may initiate various operations with respect to the electronic mail message via various “buttons” provided in the template. For instance, a user may initiate the sending of the electronic mail message via a “Send” button 212. Similarly, the user may choose to “Save” an electronic mail message that has been generated using a “Save Now” button 214. At this time, the electronic message may be saved to memory. Specifically, a data structure or file may store the electronic mail message including any content that has been added in accordance with the disclosed embodiments. Alternatively, the user may choose to discard an electronic mail message without saving the electronic mail message by clicking on a “Discard” button 216.

The user may submit a search query via an input portion 218 of the graphical user interface. In addition, a search may be initiated via a “Search” button 220 of the graphical user interface. As shown in this example, the graphical user interface may include the input portion 218, as well as the template 202. Accordingly, the user may generate a message (or document) and perform a search via a single graphical user interface.

FIG. 3 is a diagram illustrating the example graphical user interface shown in FIG. 2 via which search results may be presented after the search query has been executed. As shown in this example, the user has submitted a query “delfina” in the input portion 218 of the graphical user interface. As will be described in further detail below, the user may search local and/or remote databases via the graphical user interface.

Once the search query has been executed, search results may be presented via a search portion 302 (or pane) of the graphical user interface. The search portion 302 of the graphical user interface may be presented such that the search portion 302 is visible simultaneously with the template 102 and the message being generated. The search portion 302 may partially overlap the template 102, as shown. However, the search portion 302 and the template 102 may both be substantially and simultaneously visible in the same graphical user interface or window. The template 102 may be integral with (e.g., connected to) the input portion 218 and/or the search portion 302 of the graphical user interface. Thus, the template 102, the input portion 218, and/or the search portion 302 may be presented via a single graphical user interface, screen, or window. However, the template 102, input portion 218 and/or search portion 302 of the graphical user interface may be displayed in the form of separate portions (e.g., windows or panes) of the graphical user interface. In this manner, the template 102, input portion 218, and/or search portion 302 may be displayed and/or refreshed independently or at different times. Thus, the input portion 218 and/or the search portion 302 may be displayed and/or refreshed independent of a message (or document) being generated via the template 102.

Search results that are presented may be provided in accordance with one or more of a plurality of content types or categories 304. Content that falls into one or more of the plurality of content types or categories 304 may be added to a message or document being generated via the template 102. The plurality of content types or categories 304 may be selectable by a user. As a result, the user may designate those content types or categories for which search results are desired. For instance, the user may select one or more content types or categories via one of a plurality of tabs, as shown in this example. Specifically, as shown in FIG. 3, the user has selected the “Maps” tab, indicating that the user is interested in receiving only search results that include maps.

A search may be executed solely in accordance with the one or more of the plurality of content types or categories 304 that have been selected. In other words, only those search results that relate to the one or more of the plurality of content types or categories may be obtained. Alternatively, a search may be executed in order to obtain a set of search results of which only a subset of the search results that correspond to the one or more of the plurality of content types or categories 304 are presented. Each of the plurality of content types or categories may correspond to a different search application, search engine, search web site, data source, and/or database. Thus, a search may be executed using the query via a search application, search engine, search web site, data source, and/or database corresponding to each of the one or more of the plurality of content types or categories that have been selected. A search application, search engine, search web site, data source, and/or database may be accessible via a network such as the Internet, a wide area network (WAN), a local area network (LAN) or locally (e.g., via an application and memory coupled to a user device). In this manner, existing data sources and/or search applications may be leveraged to provide search results within the context of generating a message or document.

In this example, the content types or categories 304 are designated by tabs “Web,” “Maps,” “Video,” and “News,” respectively. “Web” may correspond generally to a search performed via a search engine over the Internet (e.g., Google or Yahoo). “Maps” may correspond to a search application that returns search results including maps and/or directions. For instance, the search may be performed via Google Maps or MapQuest. “Video” may correspond generally to a search that returns video search results via a website such as “YouTube.” “News” may correspond generally to a search that returns news search results via a search engine such as Yahoo! News. Although the content types or categories 304 are designated by tabs in this example, the content types or categories 304 may also be designated using other means, such as text or symbols (e.g., icons), in addition to or instead of tabs.

A user may scroll through search results or page through search results as shown at 306. Once a user has found search results including contents that he or she wishes to add to the message (or document), the user may add the content (e.g., content item or record item) to the message (or document). For instance, the user may click on an icon or link labeled “add to message” as shown at 308. In this manner, the user may add search content to a message or document via a single click. Alternatively, the user may add content to the message (or document) by dragging-and-dropping the content into the message (or document). The added content may then be associated with the message by storing the added content in a suitable data structure or file in memory. For instance, the added content may be stored in a temporary data structure representing the message (or document) being generated.

Once the user is finished adding content from one or more content types or categories to the message (or document), the user may close the search portion 302 of the graphical user interface such that it is no longer visible. This may be accomplished by clicking on a “close” icon or link as shown at 310. Upon sending the message, the message that has been sent may be saved by the message application. Similarly, if the user chooses to save the message without sending, the message including the content that has been added in accordance with the disclosed embodiments may be saved in a file or suitable data structure.

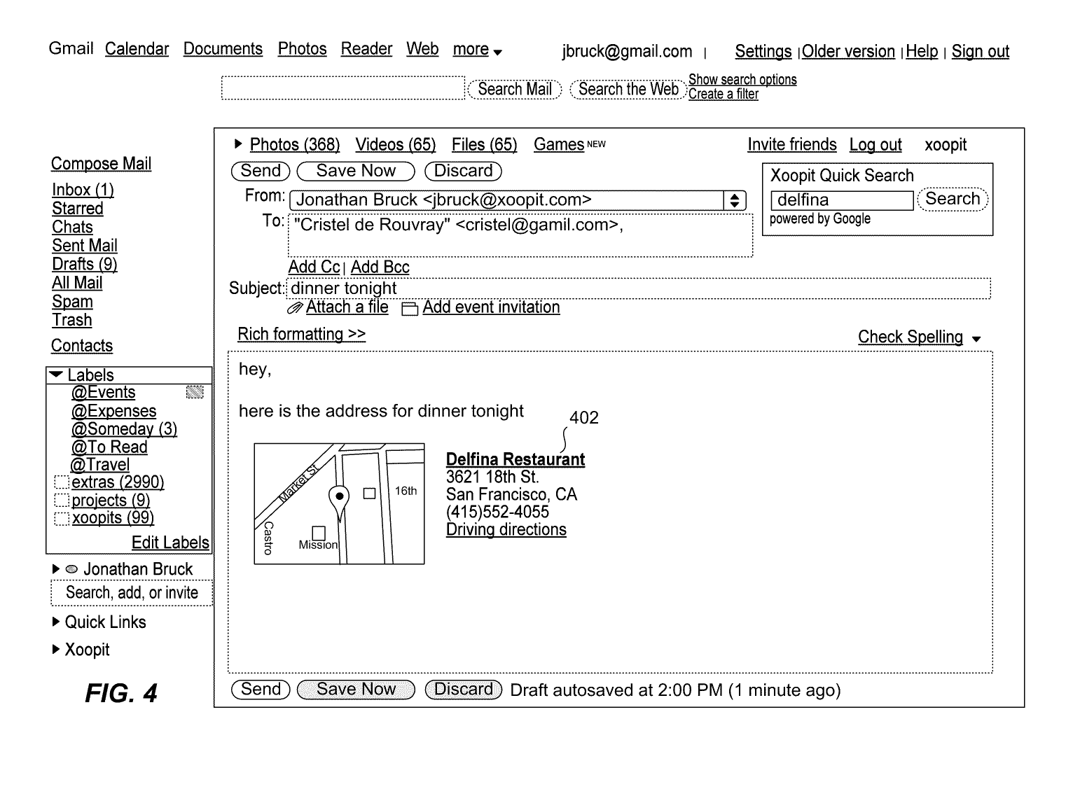

FIG. 4 is a diagram illustrating the example graphical user interface shown in FIG. 3 after selection of content from the search results to be inserted into an electronic mail message. As shown in this example, the user has chosen to add content 402 associated with a particular search result to the electronic mail message. More particularly, the user has added a map that indicates a location of Delfina Restaurant. In addition, the content that is added may include an address and/or phone number, as shown. The content that is added may further include a link (e.g., designated “Driving Directions”) which, when selected, may provide (e.g., display) driving directions to the location of Delfina Restaurant. In this example, the search portion 302 of the Graphical User Interface is no longer visible, since the user has already chosen to close the search portion 302 of the Graphical User Interface.

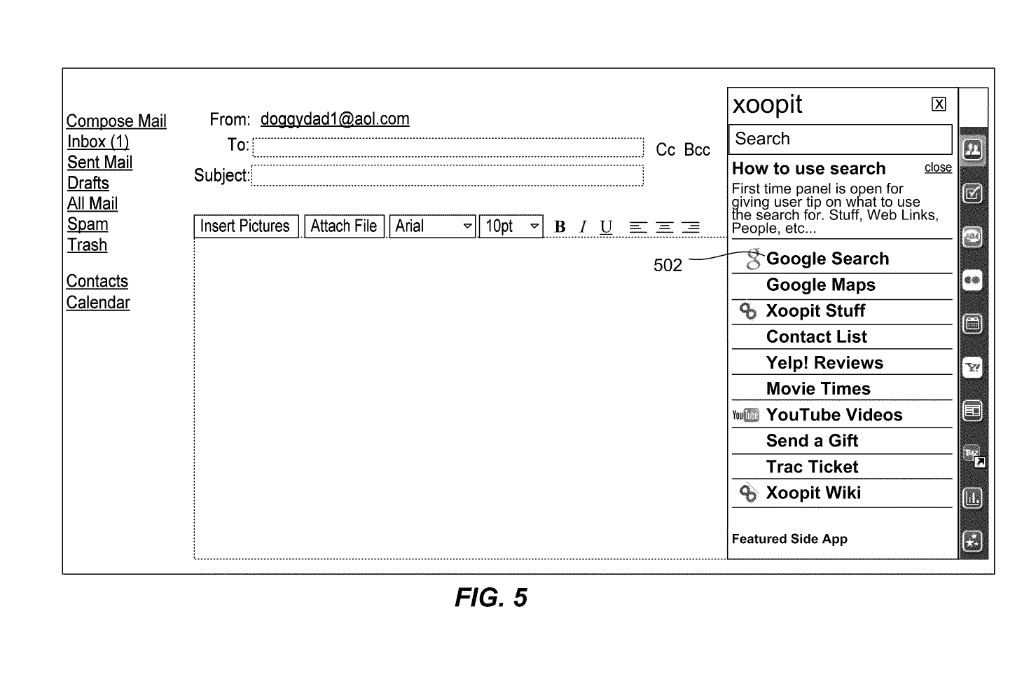

FIG. 5 is a diagram illustrating an example graphical user interface presenting a plurality of content types for which search results may be provided. As shown in this example, a plurality of content types or categories 502 may be user-selectable. In addition, the plurality of content types or categories 502 that are presented may be customizable. More particularly, an application programming interface (API) may be made accessible for use by various companies, businesses, or individuals. By making the API accessible, the number and types of parameters (e.g., input and/or output parameters) may be made available so that a content type or category such as a business, professional, or private database may be accessed via the graphical user interface. More particularly, the private database (or other “customized” content type or category) may be added as one of the plurality of content types or categories 502 so that the added content type or category may be selected via the API. In addition, adding a “customized” content type or category may include providing an indicator such as a name, picture and/or icon of the added content type or category to the search portion of the graphical user interface. In this manner, a business, professional, or private database may be searched for content that may be added to a message (or document). For example, customer information may easily be located in a customer database and added to a message (or document). As another example, a ticket or catalog number associated with a customer order may be easily identified by accessing an appropriate database. In this manner, the disclosed embodiments may be implemented to improve customer relationship management. Similarly, software bug tracking may be accomplished by accessing a bug tracking database for insertion of information (e.g., bug report ticket or identification) from the database into a message (or document).

In this example, the plurality of content types or categories 502 include “Google Search,” “Google Maps,” “Xoopit Stuff,” “Contact List,” “Yelp! Reviews,” “Movie Times,” “YouTube Videos,” “Send a Gift,” “Trac Ticket,” and “Xoopit Wiki.” As shown, the content types or categories 502 may include a private or group contact list, reviews from various web sites, movie information, etc. For instance, a “Contact List” may access a Contacts Database, which may include information such as names, addresses and/or phone numbers. A data source such as the Contacts Database may be stored remotely (e.g., via the Internet), or locally via a LAN or a memory coupled to a user device. Videos from video sharing websites such as “YouTube” may be accessed, as shown. “Send a Gift” may enable gifts such as physical gifts or virtual gifts (e.g., emoticons, graphics, or videos) to be added to a message or document. Moreover, a number of different data sources and/or search applications or web sites may be accessed via adding content types or categories to an existing set of content types or categories 502. In this manner, content from various Internet accounts (e.g., Facebook, photo sharing web sites) may be accessed. The examples of the content types or categories 502 shown and described herein are merely illustrative. Thus, there are an unlimited number of content types or categories 502 that may be made available via the graphical user interface for insertion of content into a message or document.

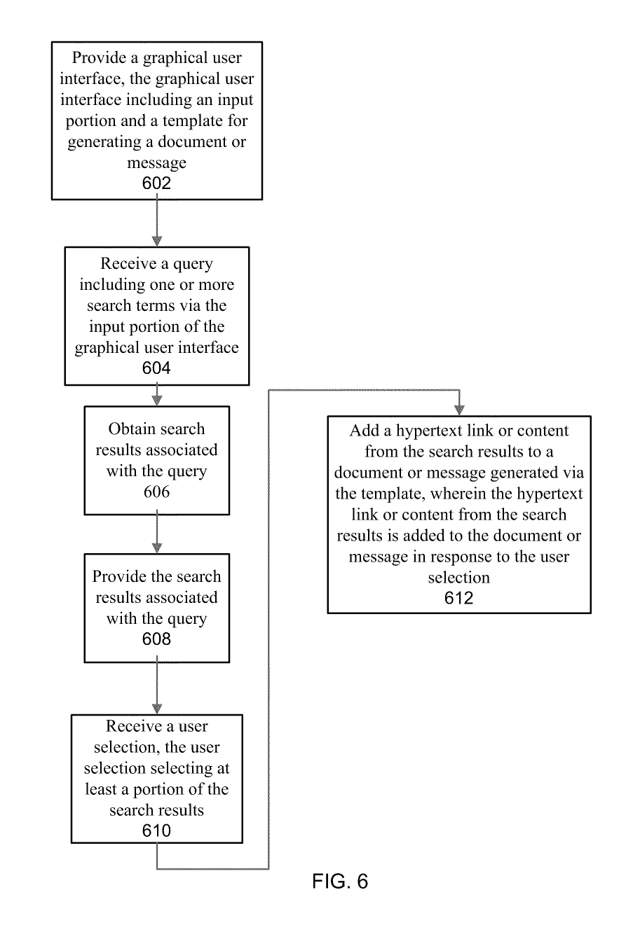

FIG. 6 is a process flow diagram illustrating an example method of adding content associated with a search query to a document or message in accordance with various embodiments of the invention. A graphical user interface may be provided at 602, where the graphical user interface includes an input portion and a template for generating a document or message. A query including one or more search terms may be received at 604 via the input portion of the graphical user interface. Search results associated with the query may be obtained at 606. The search results associated with the query may be provided at 608. A user selection may be received at 610, where the user selection selects at least a portion of the search results. A hypertext link or content from the search results may be added at 612 to a document or message generated (or being generated by) via the template, wherein the hypertext link or content from the search results is added to the document or message in response to the user selection. The document may then be sent or posted in accordance with a message or document generation application via which the template is presented. In this manner, a user may share the results of his or her search with others.

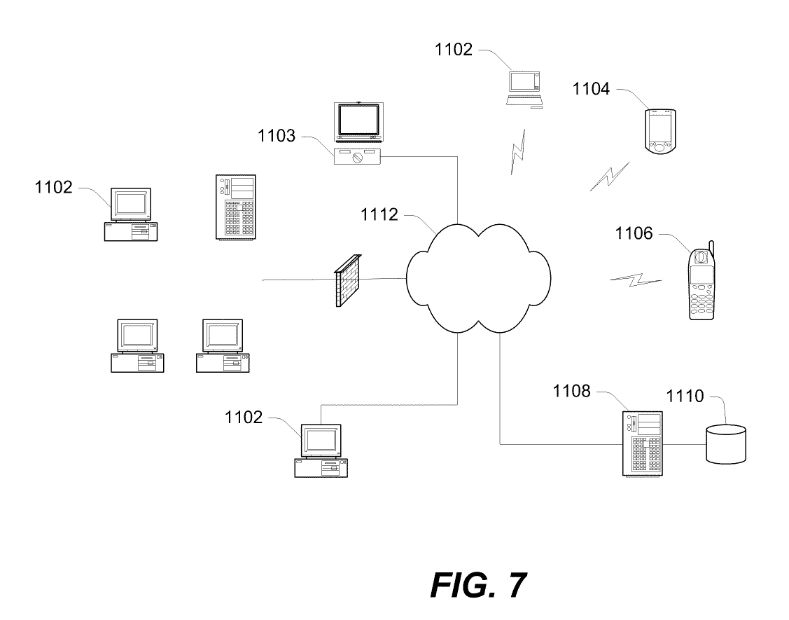

Embodiments of the present invention may be employed to perform a search via a graphical user interface while composing a message or document using the same graphical user interface. The disclosed embodiments may be implemented in any of a wide variety of computing contexts. For example, as illustrated in FIG. 7, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, a search query may be obtained via a graphical user interface from a user's interaction with a local application, web site or web-based application or service and may be accomplished using any of a variety of well known mechanisms for obtaining information from a user. However, it should be understood that such methods of obtaining input from a user are merely examples and that a search query may be obtained in many other ways.

Content may be located via a search and inserted into a message or document according to the disclosed embodiments in some centralized manner. This is represented in FIG. 7 by server 1108 and data store 1110 which, as will be understood, may correspond to multiple distributed devices and data stores. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The search apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, categories or content types to be displayed in association with the disclosed methods, search results, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

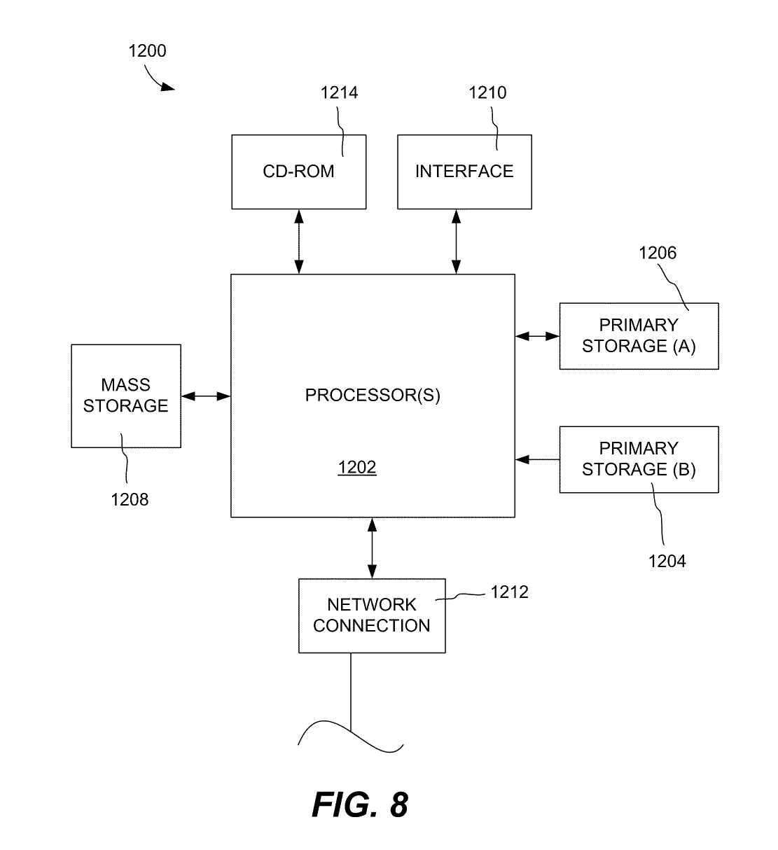

FIG. 8 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
providing a graphical user interface, the graphical user interface including an input portion and a template for generating a document or message;
receiving a query including one or more search terms via the input portion of the graphical user interface;
obtaining search results associated with the query;
providing the search results associated with the query;
receiving a user selection, the user selection selecting at least a portion of the search results; and
adding a hypertext link or content from the search results to a document or message generated via the template, wherein the hypertext link or content from the search results is added to the document or message in response to the user selection.

2. The method as recited in claim 1, wherein the user selection identifies at least one of a group consisting of: 1) one or more hypertext links from the search results; 2) one or more web sites; and 3) at least a portion of one or more web pages.

3. The method as recited in claim 1, wherein the user selection identifies a segment of text from a document provided in the search results.

4. The method as recited in claim 1, wherein the hypertext link or content includes at least one of audio or visual information, and wherein the user selection identifies at least one of a group consisting of: 1) one or more photographs, images, graphics, or other visual representations; and 2) video or audio information.

5. The method as recited in claim 1, wherein receiving a user selection comprises:
receiving a single click or dragging and dropping the hypertext link or content into the document or message.

6. The method as recited in claim 1, wherein providing search results associated with the query comprises:
providing the search results via a search portion of the graphical user interface.

7. The method as recited in claim 1, wherein providing the search results associated with the query comprises:
providing the search results such that the search results are provided adjacent to the template or overlapping the template.

8. An apparatus, comprising:
a processor; and
a memory, at least one of the processor or the memory being adapted for:
providing a graphical user interface, the graphical user interface including an input portion and a template for generating a document or message;
receiving a query including one or more search terms via the input portion of the graphical user interface;
obtaining search results associated with the query;
providing the search results associated with the query;
receiving a user selection, the user selection selecting at least a portion of the search results;
generating a document or message using the template; and
adding a hypertext link or content from the search results to the document or message in response to the user selection.

9. The apparatus as recited in claim 8, wherein generating a document or message using the template comprises generating a message using a message generation application, and wherein adding a hypertext link or content from the search results to the document or message comprises inserting the hypertext link or content to a message portion of the message or adding the hypertext link or content as one or more attachments to the message.

10. The apparatus as recited in claim 8, wherein generating a document or message using the template comprises generating a document using a document generation application, and wherein adding a hypertext link or content from the search results to the document or message comprises:
inserting the hypertext link or content to a document portion of the document or adding the hypertext link or content as one or more attachments to the document.

11. The apparatus as recited in claim 8, wherein providing search results associated with the query is performed in accordance with one or more of a plurality of content types or categories, wherein each of the plurality of content types or categories corresponds to a different search application, search engine, search web site, data source, or database, wherein obtaining search results associated with the query comprises:
executing a search using the query using a search application, search engine, search web site, data source, or database corresponding to each of the one or more of the plurality of content types or categories.

12. The apparatus as recited in claim 11, at least one of the processor or the memory being further adapted for:
providing at least one of an audio or visual indicator of the one or more of the plurality of content types or categories for which the search results are provided.

13. The apparatus as recited in claim 11, at least one of the processor or the memory being further adapted for:
providing the plurality of content types or categories, wherein the plurality of content types or categories are selectable by a user, each of the plurality of content types or categories indicating a content type or category of search results that can be provided in association with the search query;
receiving a selection of one or more of the plurality of content types or categories; and
providing the search results associated with the selected one or more of the plurality of content types or categories in response to the selection of the one or more of the plurality of content types or categories.

14. The apparatus as recited in claim 13, at least one of the processor or the memory being further adapted for:
providing at least one of an audio or visual indicator of the one or more of the plurality of content types or categories that have been selected.

15. The apparatus as recited in claim 13, wherein obtaining the search results associated with the query is performed prior to receiving the selection of the one or more of the plurality of content types or categories, and wherein providing the search results comprises:
providing only a portion of the obtained search results, the portion of the obtained search results corresponding to the one or more of the plurality of content types or categories that have been selected.

16. The apparatus as recited in claim 13, wherein obtaining the search results associated with the query is performed after receiving the selection of the one or more of the plurality of content types or categories, and wherein obtaining the search results comprises:
executing a search using the query and the one or more of the plurality of content types or categories that have been selected.

17. The apparatus as recited in claim 16, wherein each of the plurality of content types or categories corresponds to a different search application, search engine, search web site, data source, or database, wherein executing the search using the query and the one or more of the plurality of content types or categories that have been selected comprises:
executing a search using the query using a search application, search engine, search web site, data source, or database corresponding to each of the one or more of the plurality of content types or categories that have been selected.

18. The apparatus as recited in claim 13, wherein providing the plurality of content types or categories comprises:
providing a user interface including the template and indicating the plurality of content types or categories.

19. A computer-readable medium storing thereon computer-readable instructions, comprising:
instructions for providing a graphical user interface, the graphical user interface including an input portion and a template for generating an electronic message, the template for generating an electronic message including a message portion;
instructions for obtaining a query including one or more search terms via the input portion of the graphical user interface;
instructions for obtaining search results associated with the query;
instructions for providing the search results associated with the query;
instructions for obtaining a user selection, the user selection selecting at least a portion of the search results; and
instructions for adding a hypertext link or content from the search results to an electronic message generated via the template, wherein the hypertext link or content from the search results is added to the electronic message in response to the user selection

20. The computer-readable medium as recited in claim 19, wherein the electronic message is an electronic mail message, the computer-readable medium further comprising:
instructions for generating the electronic message using the template; and
instructions for sending the electronic message.

21. The computer-readable medium as recited in claim 19, wherein adding a hypertext link or content from the search results to the electronic message comprises:
adding the hypertext link or content to the message portion of the template.

22. The computer-readable medium as recited in claim 19, wherein adding a hypertext link or content from the search results to the electronic message generated via the template comprises:
adding the hypertext link or content to a message portion of the electronic message generated via the message portion of the template.

23. The computer-readable medium as recited in claim 19, wherein adding a hypertext link or content from the search results to the electronic message in response to the user selection comprises:
adding the hypertext link or content as one or more attachments to the electronic message.

24. The computer-readable medium as recited in claim 19, wherein the hypertext link or content provides at least one of a map or directions to a location.

25. The computer-readable medium as recited in claim 24, wherein the map at least one of includes the location or provides a visual representation of the directions to the location.

26. The computer-readable medium as recited in claim 25, wherein the location corresponds to the search query.
